(19) United States
(12) Patent Application Publication
(10) Pub. No.: US 2013/0206298 A1
(43) Pub. Date: Aug. 15, 2013

(54) PNEUMATIC TIRE TREAD COMPRISING A PLURALITY OF INCISIONS

(71) Applicants: Christian Guillermou, Clermont-Ferrand (FR); Eric Berger, Clermont-Ferrand (FR)

(72) Inventors: Christian Guillermou, Clermont-Ferrand (FR); Eric Berger, Clermont-Ferrand (FR)

(73) Assignee: Michelin Recherche Et Technique S.A., Granges-Paccot (CH)

(21) Appl. No.: 13/821,447

(22) PCT Filed: Sep. 9, 2011
(86) PCT No.: PCT/EP2011/065616

§ 371 Date: Mar. 29, 2013

(30) Foreign Application Priority Data
Sep. 9, 2010 (FR) 1057149

(51) Int. Cl. B60C 11/12

(52) U.S. Cl. CPC B60C 11/1272
USPC 152/209.18

(57) ABSTRACT

A tread comprises a central zone with a width of between 70% and 80% of the width W of the tread. The central zone comprises one or more circumferential bands, each being delimited by two grooves of a width greater than or equal to 2 mm, and each comprising a contact surface intended to come into contact with the ground and a plurality of transverse sipes distributed evenly in the circumferential direction. Each sipe has, on the contact surface, a width less than 2 mm so as to define a mean circumferential void ratio, which is between 0.5 times and 1.5 times the ratio between a mean thickness (E) of the circumferential band to a mean circumferential radius of curvature (Rc) of the said circumferential band. The sipes divide the circumferential band into a succession of blocks, each having two edge corners intersecting the contact surface of the circumferential band, at least one of the edge corners of said block extending radially by an inclined part forming a chamfer. This inclined part connects the edge corner to a lateral wall of the block so as to generate an offset in the circumferential direction between the said edge corner and the lateral wall of the block.

### BACKGROUND

1. Field

The present invention relates to a tire tread comprising a plurality of sipes and associated means for reducing the rolling energy consumption of this tread. The invention relates notably to treads for tires intended to be fitted to passenger motor vehicles.

2. Description of Related Art

Reducing the energy consumption associated with moving a vehicle along is an important objective sought by all motor vehicle manufacturers and constructors. It is often the case that this objective governs the development and marketing of the tires.

In order to reduce this energy consumption, one solution is to reduce the rolling resistance of the tires.

It is known that the rolling resistance of a tire being driven on is connected with the energy losses within the said tire. These energy losses are dependent on the hysteresis characteristics of the rubber compounds used in the tread. These energy losses are also dependent on the deformation cycles experienced by the tread as the tire is driven on.

More specifically, the deformations experienced by the tread are dependent on the forces applied to the said tread when the tire is being driven on. Thus, in the contact patch in which the tire makes contact with the ground, the tread is subjected to the action of forces normal to the tread surface.

In the contact patch, the tread is also subjected to the action of shear forces tangential to the surface, the said shear forces being oriented both in a circumferential direction and in a tranverse direction. Under the action of these various forces, the tread deforms, leading to energy losses through hysteresis.

Document EP0787601 discloses a tread provided with a plurality of transversely oriented sipes that allow energy losses associated with the hysteresis of the rubber compounds of which the tread is made to be limited. The width of these sipes is determined so that the sipes present in the contact patch are closed. Closure of a sipe is due to the circumferential deformation of the two blocks of material surrounding this sipe. Under the effect of the shear forces and compressive forces, the blocks are compressed and the opposing lateral walls of the said blocks deform, moving closer together. This deformation of the lateral walls leads to energy losses through hysteresis. Once the sipe has closed up, which means to say once the blocks are in contact over practically the entirety of their lateral wall, the compression of the blocks is halted. The loss of energy through hysteresis which is associated with the compression of the rubber is therefore likewise halted.

Document EP0787601 thus proposes special design rules for creating transverse sipes in the tread. Adherence to these rules makes it possible to reduce hysteresis energy losses.

The present invention proposes to improve the energy performance of a tire still further.

### Definitions

A tire means all types of resilient tire cover whether or not they are subjected during running to an internal pressure.

A tire tread means a quantity of rubber compound delimited by lateral surfaces and by two main surfaces one of which is intended to come into contact with the ground when the tire is rolling.

The central zone in the tread means a zone in the tread that is centred on the equatorial plane, namely a zone that is centred on the plane passing through the middle of the tread and perpendicular to the axis of rotation of the tire.

The width of the tread means the distance separating two axial edges of the tread. The way in which the width of a tread is determined is disclosed notably in document WO 2011/073022.

A block means a raised element of balanced dimensions, for example a cube.

A circumferential band means a collection of blocks arranged one after the other along the circumference of the tire.

A sipe means a cutout delimiting two lateral walls of two adjacent blocks, the said lateral walls touching under normal running conditions. The width of a sipe is less than 2 mm.

Where the sipes are said to be evenly distributed, this means that the total number of sipes in the contact patch where the circumferential band makes contact with the ground is on average constant whatever part of the circumferential band happens to be forming the said contact patch.

A groove means a cutout of which the faces of material do not touch under normal running conditions. The width of a groove is greater than or equal to 2 mm.

The circumferential direction means a direction tangential to a circle centred on the axis of rotation of the tire.

The transverse direction means a direction parallel to the axis of rotation of the said tire.

A radial direction means a direction perpendicular to the circumferential direction and to the transverse direction.

The mean circumferential void ratio of a circumferential band means the ratio of the surface area of the sipes belonging to the circumferential band to the contact surface area of the said band.

The contact surface of a circumferential band means the surface formed by those points on the circumferential band that come into contact with the ground when the tire is running.

The surface area of a sipe means the surface area occupied by the sipe in a plane parallel to the contact surface of the circumferential band. This parallel plane may intersect the sipe, for example, half way down the depth of the said sipe.

The mean circumferential radius of curvature of a circumferential band means the radius that this circumferential band makes in a circumferential plane. This radius is measured in the median part of the circumferential band.

The mean thickness of a circumferential band means the distance between the contact surface of the circumferential band and the surface radially on the outside of the reinforcing belt located substantially within a median part of said circumferential band.

### SUMMARY

Disclosed herein is a tire tread of width W. This tread comprises a central zone with a width of between 70% and 80% of the width W of the tread. The central zone comprises one or more circumferential bands, each circumferential band of the central zone being delimited by two grooves of a width greater than or equal to 2 mm. Each circumferential band of the central zone comprises a contact surface intended to come into contact with the ground and a plurality of transverse sipes distributed largely evenly in the circumferential direction. Each sipe has, on the contact surface, a width less than 2 mm so as to define a mean circumferential void ratio. This mean circumferential void ratio is between 0.5 times and 1.5 times the ratio between a mean thickness of the circumferential band to a mean circumferential radius of curvature of the said circumferential band. The sipes divide the circumferential band into a succession of blocks, each block having two edge corners intersecting the contact surface of the circumferential band. For each block of the circumferential band, at least one of the edge corners of the said block is extended radially by an inclined part forming a chamfer. This inclined part connects the edge corner to a lateral wall of the block in such a way as to generate an offset in the circumferential direction between the said edge corner and the said lateral wall of the block.

During running, the circumferential band is apt to adopt a first radius of curvature corresponding to the radius of curvature of an unladen inflated tire. In the contact patch, the circumferential band adopts a second radius of curvature corresponding to the radius of curvature of the ground. Ahead of the contact patch, the circumferential band adopts a third radius of curvature known as the small Koutny radius. The fact that such a small radius of curvature exists leads to a high degree of flexing of the circumferential band ahead of the contact patch. This high degree of flexing has a tendency to part the lateral walls of the adjacent blocks and therefore to widen the sipes just before they enter the contact patch, the result of this being to increase hysteresis energy losses.

In one embodiment, there is created a chamfer at a corner edge of the block. The chamfer delays the moment of contact between the block and the ground, allowing the sipe delimited by this block to begin to close up again even before the said block touches the ground. The deformation of the block as it contacts the ground is therefore limited because the space into which the said block can deform is reduced, the sipe having begun to close up.

Thanks to the chamfers, hysteresis energy losses are limited still further.

For preference, the mean circumferential void ratio is between 0.9 times and 1.1 times the ratio between the mean thickness of the circumferential band to the mean circumferential radius of curvature.

Hysteresis energy losses are limited even further.

For preference, the edge corner is offset with respect to the lateral wall by a distance at least equal to the width of the sipe delimiting the said lateral wall.

By giving the chamfers sufficient width, the desired effect is enhanced.

For preference, the edge corner is offset with respect to the lateral wall by a distance at most equal to half the distance separating the two edge corners of the block.

A loss of rigidity of the blocks is thus avoided by limiting the width of the chamfers.

For preference, the chamfer-forming inclined part has a radial height at least equal to 5% of the depth of the sipe delimiting the said lateral wall.

By giving the chamfers sufficient height, the desired effect is enhanced.

For preference, the inclined part is inclined by an angle at most equal to 45 degrees to the radial direction.

Beyond 45 degrees, the area of contact with the ground and the rigidity of the blocks is reduced excessively and this can ultimately impair the correct operation of the tread.

As an alternative, each block comprises two chamfer-forming inclined parts, each inclined part being associated with one of the edge corners of the block.

It is thus possible to manufacture non-directional tires from the tread of the invention. These non-directional tires do not have a preferred direction of running.

Alternatively, each block comprises at least one pressure pad projecting from a lateral wall of the said block, the said pressure pad comprising an active surface able to come into contact with a lateral wall of another, adjacent, block.

The pressure pads make it possible to reduce the volume of the sipes, and this limits even further still the deformation of the blocks as they come into contact with the ground. Hysteresis energy losses are therefore limited even more.

For preference, each pressure pad extends the chamfer-forming inclined part.

Because the pressure pads are as close as possible to the ground, their deformation is at a maximum when the tread makes contact with the ground. The volume of the sipes is thus reduced further.

Alternatively, the sipes are inclined by an angle at most equal to 45 degrees with respect to the radial direction.

By inclining the sipes in the depth of the tread, better closure of said sipes can be ensured. The deformation of the blocks is thus limited even further.

### BRIEF DESCRIPTION OF THE DRAWINGS

Further features and advantages of the invention will become apparent from the following description, given by way of nonlimiting example, with reference to the attached drawings in which:

FIG. 1 schematically depicts a partial view in cross section of a tire comprising a tread according to the invention;

FIG. 2 schematically depicts a partial view of the tread surface of the tread of FIG. 1;

FIG. 3 depicts a view in circumferential section of part of the tread of FIG. 1, at rest;

FIG. 4 depicts an enlarged view of a block of FIG. 3;

FIG. 5 depicts a view in circumferential section of part of the tread of FIG. 1 in contact with the ground;

FIG. 6 depicts a second alternative form of the tread of FIG. 1;

FIG. 7 depicts a third alternative form of the tread of FIG. 1;

FIG. 8 depicts a fourth alternative form of the tread of FIG. 1;

FIG. 9 depicts a fifth alternative form of the tread of FIG. 1.

### DETAILED DESCRIPTION OF SPECIFIC EMBODIMENTS

In the description that follows, elements that are identical or similar will be denoted by identical references.

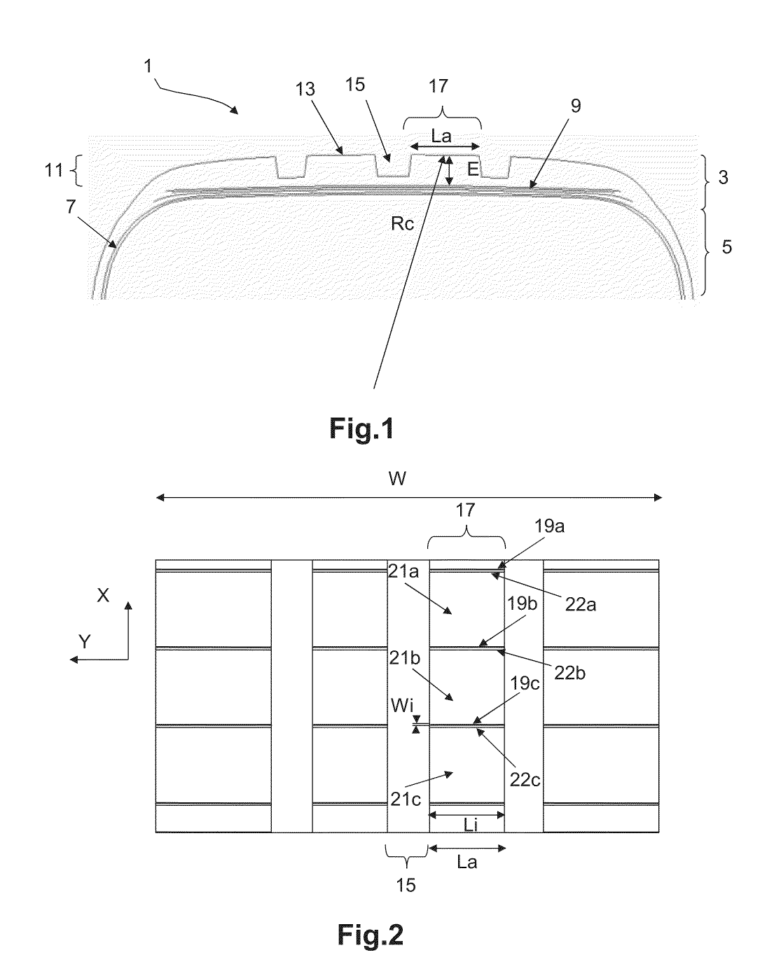

FIG. 1 schematically depicts a partial view in cross section of a tire 1.

The tire 1 comprises a crown comprising a crown region 3 extended laterally by sidewalls 5 connecting to beads (not depicted) intended to be in contact with a mounting rim.

The tire 1 comprises a carcass reinforcement 7 extending from one bead to the other bead via the sidewalls 5 and the crown region 3.

The crown region 3 comprises a reinforcement 9 surmounted radially on the outside by a tread 11.

The tread 11 comprises, radially on the outside, a tread surface 13 intended to come into contact with the ground when the vehicle is running.

The tread 11 comprises a plurality of grooves 15.

The grooves 15 delimit raised circumferential bands 17.

Each circumferential band 17 has a contact surface intended to come into contact with the ground when the tire is rolling along. All of the contact surfaces of the various circumferential bands together form the tread surface of the tire.

The circumferential band 17 has a mean thickness E. The mean thickness E is measured here in the middle of the width La of the circumferential band 17 between the contact surface of the circumferential band 17 and the reinforcement 9.

The circumferential band 17 also has a mean circumferential radius of curvature Rc measured at the middle of the width La of the circumferential band 17.

FIG. 2 schematically depicts a partial view of the tread surface of the tread.

The circumferential band 17 is provided with a first sipe 19a, with a second sipe 19b and with a third sipe 19c. The sipes 19a, 19b, 19c here are oriented essentially transversely. The sipes 19a, 19b, 19c respectively delimit a first block 21a, a second block 21b and a third block 21c.

The number of sipes in the circumferential band and the characteristics of the said sipes are determined in such a way that the mean circumferential void ratio of the circumferential band 17 is between 0.5 times and 1.5 times the ratio between the mean thickness E of the tread to the mean circumferential radius of curvature Rc.

Thus, the number of sipes N, the width of the sipes Wi, the length of the sipes Li, the width of the circumferential band La are determined so that the following equation is satisfied:

$$0.5 \times E / Rc \leq \frac{Wi \times N \times Li}{La \times 2 \times Π \times Rc} \leq 1.5 \times E / Rc$$

By way of example, for a tire of size 205/55R16 inflated to its nominal pressure, the mean thickness E is 10 mm, the mean circumferential radius of curvature Rc is 315 mm, the width Wi of the sipes is 0.8 mm, the length of the sipes Li is 20 mm, the number of sipes N is 90, and the width La of the circumferential band is 20 mm. It is considered here that the width of the sipes Wi is constant within the depth of the sipe. This width is determined in a plane parallel to the contact surface. This parallel plane here intersects the sipe half way down the depth of the said sipe.

In an alternative form of embodiment, the number of sipes in the circumferential band and the characteristics of the said sipes are determined so that the void ratio of the circumferential band 17 is between 0.9 times and 1.1 times the ratio between the mean thickness E of the tread to the mean circumferential radius of curvature Rc.

In another alternative form of embodiment, the number of sipes in the circumferential band is greater than 110.

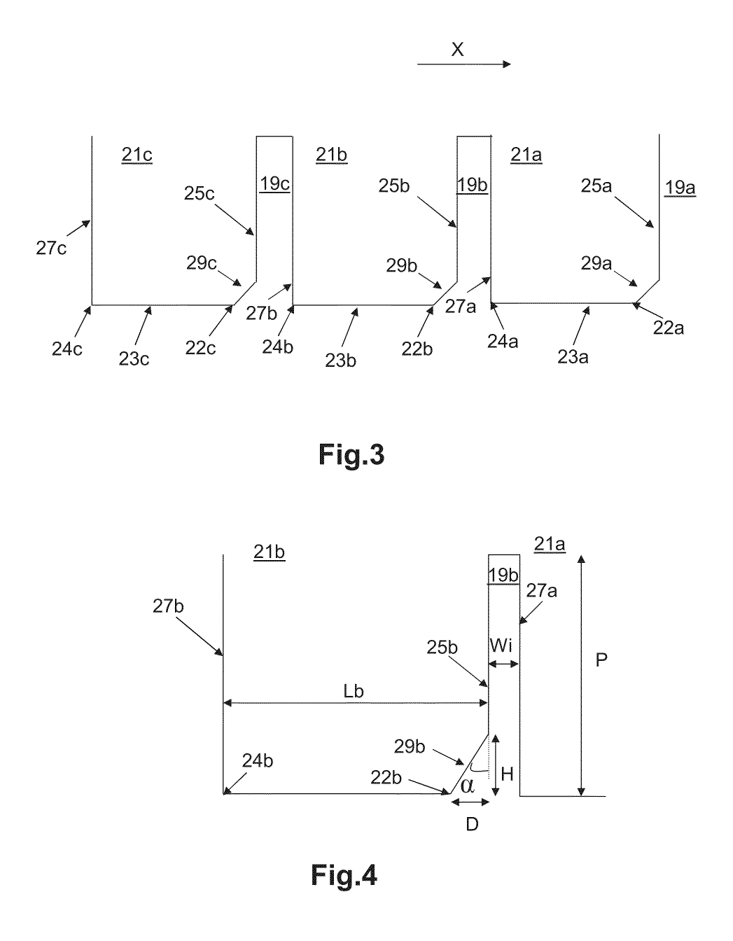

FIG. 3 schematically depicts a view in circumferential section of the blocks 21a, 21b, 21c at rest, i.e. when the blocks are not in contact with the ground.

Each block 21a, 21b, 21c comprises an external surface 23a, 23b, 23c intended to come into contact with the ground.

Each block 21a, 21b, 21c comprises a first edge corner 22a, 22b, 22c and a second edge corner 24a, 24b, 24c.

In addition, each block 21a, 21b, 21c comprises a first lateral wall 25a, 25b, 25c and a second lateral wall 27a, 27b, 27c. The lateral walls of the blocks are walls with a transverse orientation.

The first sipe 19a is thus partially delimited by the first lateral wall 25a of the first block 21a.

The second sipe 19b is delimited by the second lateral wall 27a of the first block 21a and by the first lateral wall 25b of the second block 21b.

The third sipe 19c is delimited by the second lateral wall 27b of the second block 21b and by the first lateral wall 25c of the third block 21c.

Each block 21a, 21b, 21c comprises an inclined part 29a, 29b, 29c that forms a chamfer. The inclined part 29a, 29b, 29c here is in the form of an inclined plane.

Each inclined part 29a, 29b, 29c thus respectively connects the first lateral wall 25a, 25b, 25c of each block 21a, 21b, 21c to the first edge corner 22a, 22b, 22c in such a way as to create an offset between the first edge corner and the first lateral wall.

FIG. 4 schematically depicts an enlarged view of the second block 21b.

The first edge corner 22b is offset from the first lateral wall 25b by a distance D at least equal to the width Wi of the second sipe 19b. The width Wi of the second sipe 19b is equal to the distance between the second lateral wall 27a of the first block and the first lateral wall 25b of the second block 21b. Thus, for a sipe of width 0.8 mm, the distance D is, for example, of the order of 1 mm.

It will be noted that the width Wi is determined in a plane parallel to the contact surface. This plane is distant from the inclined part so that the widening created by the chamfer is not taken into consideration in calculating the width Wi.

Similarly, the distance D is at most equal to half the distance Lb between the first lateral wall 25b and the second lateral wall 27b of the second block 21b.

In an alternative form of embodiment, the distance D is greater than Wi/2 and less than 2×Wi.

It will be noted that the inclined part 29b has a radial height H at least equal to 5% of the depth P of the second sipe 19b.

The radial height H of the inclined part is, for example, of the order of 1.5 mm.

Further, the inclined part 29b is inclined by an angle a at most equal to 45 degrees with the radial direction.

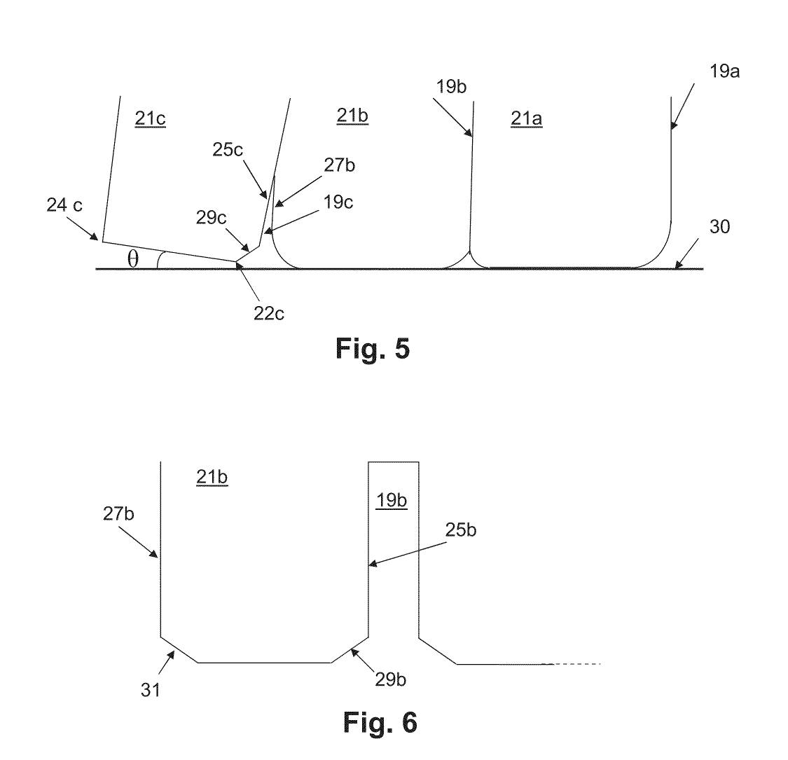

FIG. 5 depicts a circumferential section of part of the tread in contact with the ground.

In this circumferential section, the first block 21a and the second block 21b are in contact with the ground 30 over their entire contact surface. The blocks 21a, 21b are compressed and their respective lateral walls are deformed such that the sipes 19a, 19b are closed.

FIG. 5 depicts the third block 21c just before it touches the ground 30 at the first edge corner 22c.

The third block 21c is about to touch the ground 30 with an angle of attack 8.

Thanks to the inclined part, the angle of attack θ is small here and the distance between the second lateral wall 27b of the second block 21b and the first lateral wall 25c of the third block 21c is reduced. The third sipe 19c is therefore partially closed even before the first edge corner 22c touches the ground.

During contact between the third block 21c and the ground 30, the first lateral wall 25c will deform but the magnitude of this deformation is reduced because the space that there is between the second block 21b and the third block 21c is small, because of the offset generated by the inclined part 29c.

It will be noted that, in the example of FIG. 5, the first edge corner 22c is a leading edge corner and the second edge corner 24 is a trailing edge corner, which means to say an edge corner that comes into contact with the ground after the leading edge corner.

In a second alternative form of embodiment visible in FIG. 6, each block 21b comprises two chamfer-forming inclined parts 29b, 31. Each inclined part is associated with a lateral wall 25b, 27b.

It is thus possible to manufacture non-directional tires from the tread of the invention. These non-directional tires do not have a preferred direction of running.

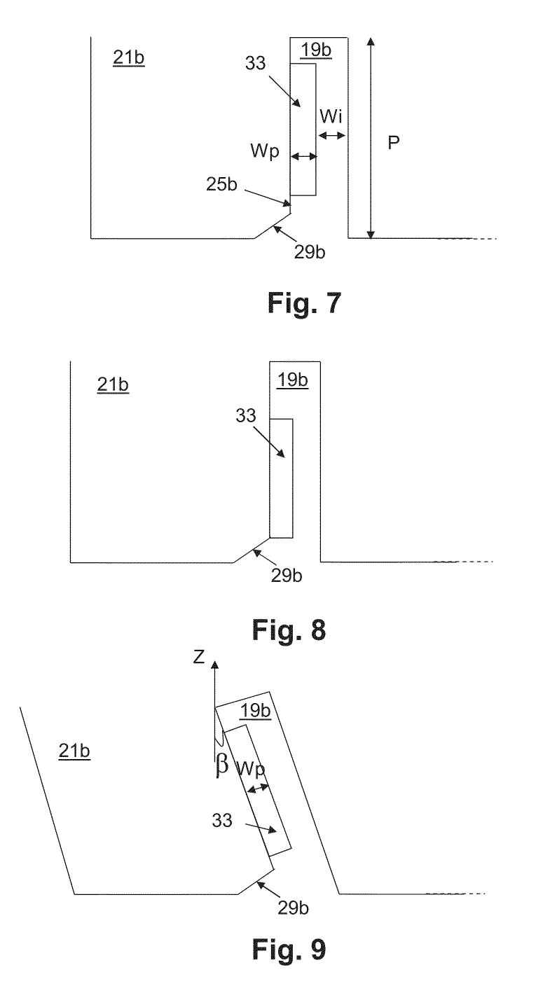

In a third alternative form of embodiment visible in FIG. 7, each block 21b comprises a pressure pad 33 projecting from a first lateral wall 25b. The pressure pad comprises an active surface able to come into contact with a block opposite.

The pressure pad makes it possible to reduce the volume of the sipe and this limits still further the ability of the blocks to deform when they come into contact with the ground.

The pressure pad is present over at least 50% of the depth P of the sipe. For example, for a sipe with a depth P of 8 mm, the pad has a height of 5 mm.

The width of the pressure pad Wp is less than half the distance between the walls that form the sipe. Thus, for a distance of 0.8 mm between the walls, the width of the pressure pad is, for example, 0.2 mm.

In this embodiment it is considered that the width Wi of the sipe corresponds to the distance between the pad and the lateral wall opposite and that the surface area of a sipe corresponds to the area formed by the said sipe in a plane perpendicular to the lateral walls delimiting the said sipe and passing through the pressure pad.

In the example of FIG. 7, the width Wi of the sipe is 0.6 mm.

As an alternative, each lateral wall comprises a half-block projecting from the said lateral wall. Each half-block thus comprises an active surface apt to come into contact with a half-block opposite.

In a fourth alternative form of embodiment visible in FIG. 8, each pressure pad 33 extends the chamfer-forming inclined part 29b.

As the pressure pads are thus as close as possible to the ground, their deformation is at a maximum when the tread makes contact with the ground. The volume of the sipes is thus reduced further.

In a fifth alternative form of embodiment, the sipes are inclined by an angle β at most equal to 45 degrees with respect to the radial direction Z.

The closing of the sipes upon contact with the ground is thus improved still further.

The invention having been thus described according to certain specific embodiments thereof, it will be appreciated that these specific embodiments are illustrative and not intended to limit the scope of the appended claims.

1. Tread for a tire comprising a central zone with a width of between 70% and 80% of a width W of the tread, the central zone comprising one or more circumferential bands, each circumferential band of the central zone being delimited by two grooves of a width greater than or equal to 2 mm, and comprising a contact surface intended to come into contact with the ground and a plurality of transverse sipes distributed evenly in the circumferential direction, each sipe having, on the contact surface, a width less than 2 mm so as to define a mean circumferential void ratio, the mean circumferential void ratio being between 0.5 times and 1.5 times the ratio between a mean thickness (E) of the circumferential band to a mean circumferential radius of curvature (Rc) of the circumferential band, the sipes dividing the circumferential band into a succession of blocks, each block having two edge corners intersecting the contact surface of the circumferential band, wherein, for each block of the circumferential band, at least one of the edge corners of the block is extended radially by an inclined part forming a chamfer, the inclined part connecting the edge corner to a lateral wall of the block in such a way as to generate an offset in the circumferential direction between the said edge corner and the lateral wall of the block.

2. Tread according to claim 1, wherein the mean circumferential void ratio is between 0.9 times and 1.1 times the ratio between the mean thickness of the circumferential band to the mean circumferential radius of curvature.

3. Tread according to claim 1, wherein the edge corner is offset with respect to the lateral wall by a distance (D) at least equal to the width (Wi) of the sipe delimiting the lateral wall.

4. Tread according to claim 1, wherein the edge corner is offset with respect to the lateral wall by a distance (D) at most equal to half the distance (Lb) separating the two edge corners of the said block.

5. Tread according to claim 1, wherein the chamfer-forming inclined part has a radial height (H) at least equal to 5% of the depth (P) of the sipe delimiting the lateral wall.

6. Tread according to claim 1, wherein the inclined part is inclined by an angle (α) at most equal to 45 degrees to the radial direction.

7. Tread according to claim 1, wherein each block comprises two chamfer-forming inclined parts, each inclined part being associated with one of the edge corners of the block.

8. Tread according to claim 1, wherein the block comprises at least one pressure pad projecting from a lateral wall of the block, the pressure pad comprising an active surface able to come into contact with a lateral wall of another, adjacent, block.

9. Tread according to claim 8, wherein each pressure pad extends the chamfer-forming inclined part.

10. Tread according to claim 1, wherein the sipes in the circumferential band are inclined radially by an angle (β) at most equal to 45 degrees with respect to the radial direction (Z).
